(19) United States
(12) Patent Application Publication
(10) Pub. No.: US 2022/0348163 A1
(43) Pub. Date: Nov. 3, 2022

(54) VEHICLE LOCK CONTROLLING SYSTEM

(71) Applicants: TOYOTA JIDOSHA KABUSHIKI KAISHA, Toyota-shi Aichi-ken (JP); AISIN CORPORATION, Kariya Aichi (JP)

(72) Inventors: Atsushi Shiota, Toyota-shi Aichi-ken (JP); Hajime Sasaki, Nagoya-shi Aichi-ken (JP); Yuji Utoh, Nagoya-shi Aichi-ken (JP); Hiroshi Mikoshi, Okazaki-shi Aichi-ken (JP); Yuki Fujii, Kariya-shi Aichi-ken (JP)

(73) Assignees: TOYOTA JIDOSHA KABUSHIKI KAISHA, Toyota-shi Aichi-ken (JP); AISIN CORPORATION, Kariya Aichi (JP)

(21) Appl. No.: 17/730,653

(22) Filed: Apr. 27, 2022

(30) Foreign Application Priority Data
Apr. 30, 2021 (JP) 2021-077385

(51) Int. Cl. B60R 25/01; E05B 81/56; B60N 2/10; B60R 25/24

(52) U.S. Cl. CPC B60R 25/01; E05B 81/56; B60N 2/10; B60R 25/24; B60R 2325/10

(57) ABSTRACT

A door locking mechanism and a seat forward tilt locking mechanism are installed in a vehicle. When a user moves away from the vehicle, a door lock and a seat forward tilt lock are engaged. A signal for unlocking the door lock and a signal for releasing the seat forward tilt lock are differentiated from each other, to thereby protect the vehicle against theft.

### CROSS REFERENCE TO RELATED APPLICATION

This application claims priority to Japanese Patent Application No. 2021-077385 filed on Apr. 30, 2021, which is incorporated herein by reference in its entirety including the specification, claims, drawings, and abstract.

### TECHNICAL FIELD

The present disclosure relates to a vehicle lock controlling system for locking a driver's seat of a vehicle in a toward tilt position or for releasing (unlocking) the driver's seat.

### BACKGROUND

Conventionally, smart keys using wireless communication to lock or unlock doors in vehicles have been pervasive. Such a smart key can be used not only for operating, in the vicinity of a vehicle, a door lock in the vehicle via a door locking/unlocking switch arranged on a key body, but also enabling operation for locking or unlocking the door lock via an action of touching a door handle of a door after authentication of the smart key is performed in the vicinity of the vehicle.

Meanwhile, there have been known various theft techniques, such as, for example, a technique of intercepting a wireless communication signal from a smart key and releasing a door lock using the intercepted wireless communication signal. Therefore, as measures against the theft techniques, further improvement in communication security is desired.

Patent Document 1 (JP S63-247151 A) suggests that vehicle security can be improved by locking a reclining seat in a forward tilt position.

### CITATION LIST

### Patent Literature

Patent Document 1: JP S63-247151 A

Various suggestions have been made to improve both convenience in operation and security of vehicles. However, because the theft techniques are also progressing, it is necessary to make further improvements in security of vehicles. Therefore, improvement in a technique of locking a seat in a forward tilt position is also desirable.

### SUMMARY

A vehicle lock controlling system according to the present disclosure comprises a door locking mechanism which locks and unlocks a door in a vehicle, a seat forward tilt locking mechanism which engages or releases a seat forward tilt lock in a driver's seat, and a control unit which controls the door locking mechanism and the seat forward tilt locking mechanism, in which the control unit is configured to cause, when a door unlocking signal is received, the door locking mechanism to unlock the door, and cause, when a seat forward tilt lock releasing signal is received, the seat forward tilt locking mechanism to release the seat forward tilt lock, the seat forward tilt lock releasing signal being different from the door unlocking signal.

Operation to engage the seat forward tilt lock comprises tilting the driver's seat forward and lowering a sitting surface of the driver's seat, while operation to release the seat forward tilt lock comprises recovering the driver's seat from a forward tilt position and the sitting surface from a lowered position, and the control unit may be configured to cause the seat forward tilt locking mechanism to engage the seat forward tilt lock when a seat forward tilt locking signal is received after the door is closed, and not to cause the seat forward tilt locking mechanism to engage the seat forward tilt lock when the seat forward tilt locking signal is received while the door is open.

The control unit may be configured to allow the door locking mechanism to unlock the door after the seat forward tilt lock is released, and not to allow the door locking mechanism to unlock the door while the seat forward tilt lock is engaged.

The seat forward tilt lock releasing signal may be wirelessly transmitted by pressing a seat forward tilt locking switch disposed on a smart key.

The seat forward tilt lock releasing signal may be wirelessly transmitted by turning on a switch in an application installed in a mobile terminal.

The seat forward tilt lock releasing signal may be wirelessly transmitted from a communication center.

When the seat forward tilt lock is released using the seat forward tilt lock releasing signal which is different from the door unlocking signal for unlocking the door in the vehicle, the seat forward tilt lock releasing signal can function to protect the vehicle from theft, which can, in turn, improve security of the vehicle.

### BRIEF DESCRIPTION OF DRAWINGS

Embodiments of the present disclosure will be described based on the following figures, wherein:

FIG. 1 is a block diagram showing a general configuration of a vehicle lock controlling system according to an embodiment;

FIG. 2 is an explanatory diagram for illustrating movement of a driver's seat 40 and a locking mechanism of the driver's seat 40;

FIG. 3 is a perspective view showing an example of an outer appearance of a smart key 10;

FIG. 4 is a block diagram showing components of the smart key 10;

FIG. 5 is a flowchart of a process for controlling a seat forward tilt locking operation;

FIG. 6 is a flowchart of a process for controlling a seat forward tilt lock releasing operation;

FIG. 7 is a diagram showing a system in a case of using a mobile terminal 50; and

FIG. 8 is a flowchart of a process for controlling a reservation of the seat forward tilt lock releasing operation via the mobile terminal 50.

### DESCRIPTION OF EMBODIMENTS

Hereinafter, embodiments of the present disclosure will be explained with reference to the drawings. It should be noted that the present disclosure is not limited to the embodiments described herein.

### General Configuration

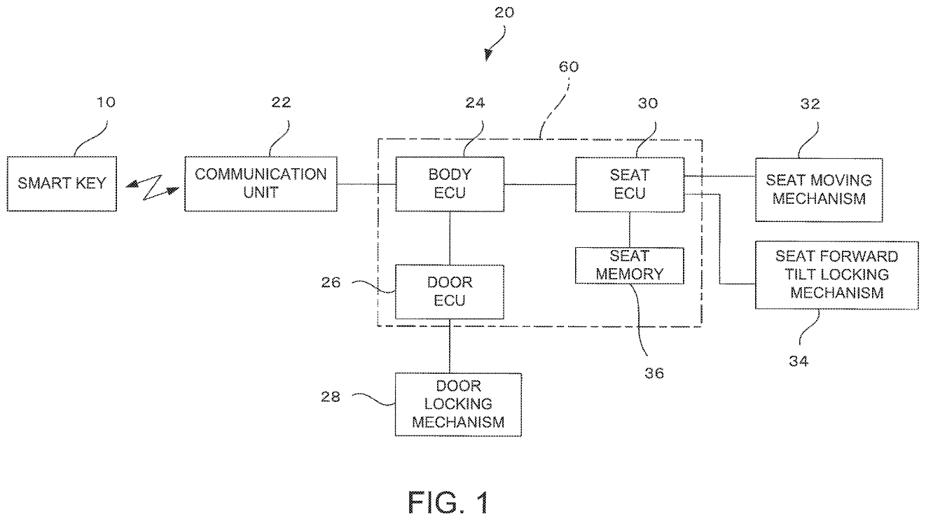

FIG. 1 is a block diagram showing a general configuration of a vehicle lock controlling system according to an embodiment.

As shown in FIG. 1, the vehicle lock controlling system includes a smart key 10 which is a portable communication device carried by a user (such as a driver, for example), and an onboard device 20 mounted on a vehicle.

The smart key 10 is a carriable small communication device and is capable of performing a predetermined authentication process via wireless communication and transmitting operation signals including a door locking signal for locking a door lock, a door unlocking signal for unlocking the door lock, a seat forward tilt locking signal for engaging a seat forward tilt lock, and a seat forward tilt lock releasing signal for releasing the seat forward tilt lock.

The onboard device 20 includes a communication unit 22 configured to wirelessly communicate with the smart key 10. Low frequency (30 to 300 kHz) waves are often used for radio waves transmitted from the communication unit 22 installed in the vehicle toward the smart key 10, while microwaves (0.3 to 3 GHz) are often used for radio waves transmitted from the smart key 10 toward the vehicle, but the radio waves are not limited to those frequency waves.

The communication unit 22 is connected to a body ECU 24. The body ECU 24 functions to perform various control operations on the vehicle. Among the control operations, operations to control a door lock and control movement and a lock of a seat are explained below according to this embodiment.

The body ECU 24 is connected to a door locking mechanism 28 via a door ECU 26. A door locking signal and a door unlocking signal transmitted from the smart key 10 are supplied through the communication unit 22 and the body ECU 24 to the door ECU 26, and the door ECU 26 controls the door locking mechanism 28 to lock or unlock a door lock of a door in a vehicle. The door locking mechanism 28 has a locking mechanism, which is typically a mechanical locking arrangement, and mechanically actuates the locking mechanism to lock or unlock the door lock.

The body ECU 24 is further connected to a seat ECU 30, and the seat ECU 30 is connected to a seat moving mechanism 32. The seat moving mechanism 32 includes a mechanical arrangement configured to control front to rear movement of a seat and vertical movement of the seat (in particular, a sitting surface of the seat), and adjust tilting (angle) of a seat back, for example. The seat ECU 30 is also connected to a seat forward tilt locking mechanism 34 which is configured to lock a seat in a forward tilt position (forward tilt lock) or release the seat from the forward tilt position. It should be noted that while the seat forward tilt lock is applied to a driver's seat in this embodiment, the seat forward tilt lock may be applied to a front passenger seat.

In addition, the seat ECU 30 is connected to a seat memory 36 in which data about seat position are stored. For example, when a user adjusts a seat position to a particular position and provides an instruction for storing the particular position, the particular position is stored as a specified position in the seat memory 36. It should be noted that a plurality of specified positions may be stored. When the user gives an instruction to set the seat at the specified position stored in the seat memory 36, the seat is moved to the specified position as instructed. In a case where the plurality of specified positions are stored, priorities may be assigned to the plurality of specified positions, and the seat may be moved to one of the specified positions that is assigned the highest priority. Alternatively, an initial position of the seat may be stored in advance of shipment of a vehicle from a factory, and the seat may be moved to the initial position in response to the instruction to set the seat at the specified position unless a particular position is specified by the user. Such setting and other operations may be performed using a touch panel on a screen connected to the body ECU 24, for example.

In this embodiment, a seat forward tilt locking position is stored in the seat memory 36. The seat forward tilt locking position is a position of the seat being moved forward with the sitting surface being lowered to a predetermined height and the seat back being tilted forward. The seat forward tilt locking position, which is typically a predetermined position and is not changed, may be internally stored in the seat ECU 30. On the other hand, when the seat forward tilt locking position is stored in the seat memory 36, the seat can be moved to the seat forward tilt locking position by a control operation similar to a general operation to control the seat position.

The seat ECU 30 controls the seat moving mechanism 32 in response to the seat forward tilt locking signal to move the seat to a forward and downward position and tilt the seat back forward, and subsequently causes the seat forward tilt locking mechanism 34 to lock the seat in the forward and downward position for disabling movement of the seat (engage the seat forward tilt lock). On the other hand, in response to the seat forward tilt lock releasing signal, the seat ECU 30 causes the seat forward tilt locking mechanism 34 to unlock the seat (the seat forward tilt lock is released).

Additionally, an intruder sensor for detecting an illegal entry into the vehicle, for example, may be installed to issue an intrusion alarm, and the driver's seat may be locked in the seat forward tilt locking position when the alarm is issued.

It should be noted that the body ECU 24, the door ECU 26, the seat ECU 30, and the seat memory 36 are incorporated into a control unit 60 in this embodiment.

### Seat Forward Tilt Lock

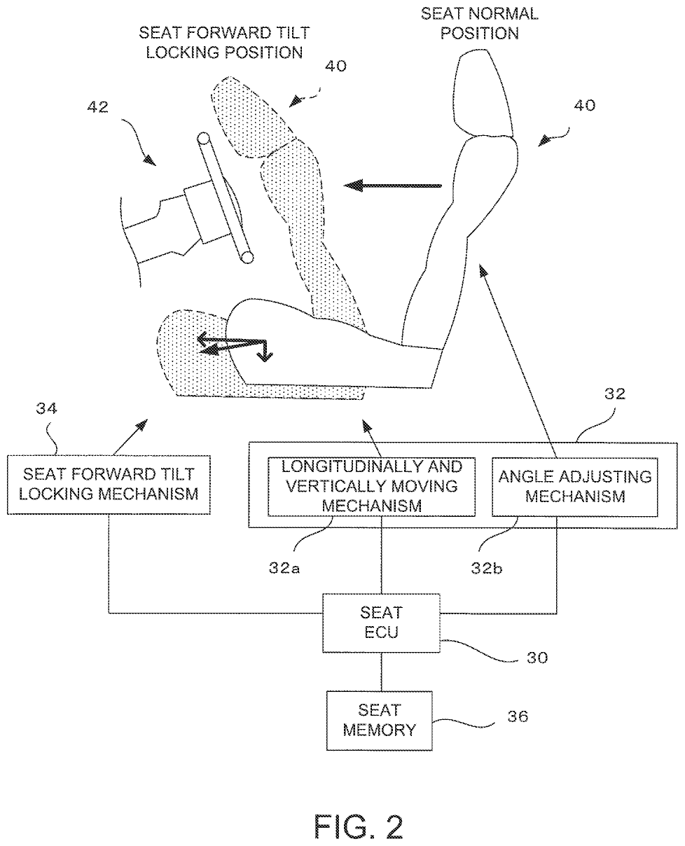

FIG. 2 is an explanatory diagram for illustrating movement of a driver's seat 40 and the locking mechanism. The seat moving mechanism 32 has a longitudinally and vertically moving mechanism 32a and an angle adjusting mechanism 32b. The longitudinally and vertically moving mechanism 32a moves the entire seat along a longitudinal direction while shifting the entire seat along a vertical direction with the sitting surface being moved up or down (being raised or lowered). For example, the driver's seat 40 may be supported on a base via a vertically expandable mechanism, and the base may be movably mounted on a rail extending along the longitudinal direction. Meanwhile, the angle adjusting mechanism 32b may be configured to pivot the seat back about a hinge, for example, that is designed to connect a rear end of a seat cushion and a lower end of the seat back.

The seat forward tilt locking mechanism 34 may be configured to lock the seat in the seat forward tilt locking position, for example, using an appropriate device, such as a claw-shaped lock which is designed to be hooked on a pin disposed on the seat back for fixing the seat back.

Here, because a steering wheel 42 is installed in front of the driver's seat 40, a forward end of the seat back of the driver's seat 40 is located close to the steering wheel 42 in the seat forward tilt locking position. Therefore, a driver is unable to sit on the driver's seat 40, which can prevent the vehicle from being driven by a thief and accordingly provide improved security. Additionally, the steering wheel 42 may be configured to be movable, and may be moved toward a rear part of the vehicle to further reduce a space between the steering wheel 42 and the driver's seat 40 when the seat forward tilt lock is engaged.

### Smart Key

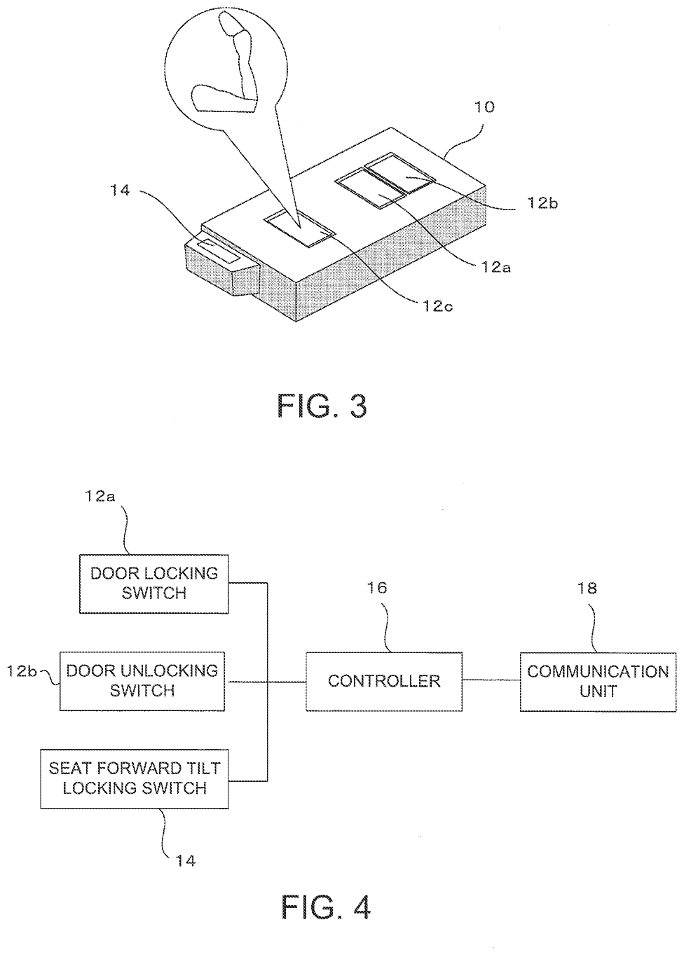

FIG. 3 is a perspective view showing an example of an outer appearance of the smart key 10. As shown in FIG. 3, the smart key 10 is generally formed in a thin box shape, and is equipped with three buttons for a door locking switch 12a, a door unlocking switch 12b, and a seat forward tilt locking switch 12c disposed on a top surface of the smart key 10. A key holder hole 14 is defined in a region protruded from a side located on one end of the smart key 10 to receive a key holder ring or the like.

FIG. 4 is a block diagram showing components of the smart key 10. The three buttons for the door locking switch 12a, the door unlocking switch 12b, and the seat forward tilt locking switch 12c are connected to a controller 16, and an operation signal from each of the switches 12a to 12c is supplied to the controller 16. The controller 16 is connected to a communication unit 18 for wirelessly communicating with the communication unit 22 in the onboard device 20.

### Door Locking/Unlocking Control

An example of operation to unlock a door is described below. The communication unit 22 in the onboard device 20 transmits radio waves toward an outside area located close to the vehicle, and the controller 16 in the smart key 10 receives through the communication unit 18 the radio waves, and upon receipt of the radio waves, initiates communication with the onboard device 20 to perform authentication processing between the smart key 10 and the onboard device 20 using an ID and a password, for example. After the authentication processing is successfully completed, the door is unlocked on a vehicle side when the user presses the door unlocking switch 12b or touches a door handle. On the other hand, the door is locked on the vehicle side when the user presses the door locking switch 12a after exiting the vehicle.

### Control of Seat Forward Tilt Lock

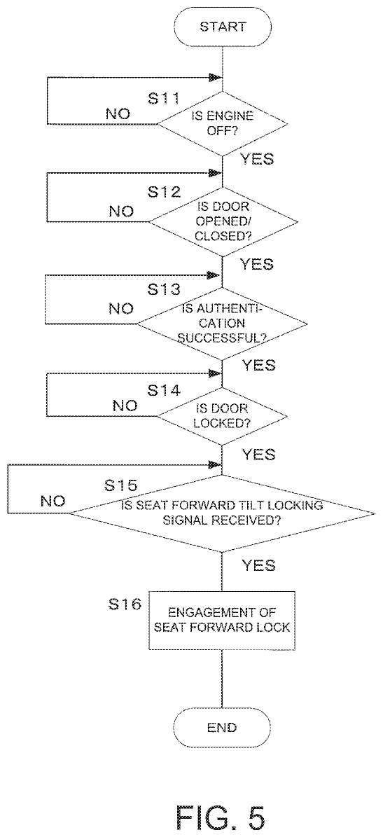

FIG. 5 shows a flowchart of a process to control the seat forward tilt lock. The process is performed, for example, in the body ECU 24 and the seat ECU 30.

Firstly, whether or not an engine of the vehicle is turned off is determined (S11). It should be noted that although an off state of the engine generally refers to a state where the engine is stopped, in this example the engine may be determined to be in the off state when the vehicle is in a driving disabled state, such as an ignition off state or a power off state.

Then, when Yes is determined in step S11, whether or not the door is opened/closed is determined (S12). Opening/closing of the door is detected based on an on/off action of a door switch, for example. Here, the door whose opening or closing is detected in this step may be limited to a driver's seat door.

When Yes is determined in step S12, it is further determined whether or not authentication of the smart key 10 using an ID or other codes is successfully completed (S13). When the authentication is successfully completed, it is determined whether or not the door is locked (S14). Here, the determination about the authentication in step S13, which is performed after steps S11 and S12 in this example, may be performed prior to either or both of the steps. Further, the door subjected to the determination as to whether or not to be locked may be limited to the driver's seat door. Alternatively, because all of the doors are generally locked by locking the driver's seat door, whether or not to be locked may be determined with respect to another door rather than the driver's seat door. The condition that the door is locked may be detected when a door locking signal is received.

When Yes is determined in step S14, it is determined whether or not the seat forward tilt locking signal is received (S15).

When Yes is determined in step S15, the seat forward tilt locking operation is performed (S16). Specifically, the seat is moved forward while being lowered, the seat back is tilted forward, and the seat is locked in this position (the seat forward tilt locking position).

In this embodiment, the seat forward tilt lock is engaged in response to the seat forward tilt locking signal only when Yes is determined in all of the four steps of S11 to S14 as described above. This can prevent erroneous activation of the seat forward tilt locking operation while the driver is sitting on the driver's seat.

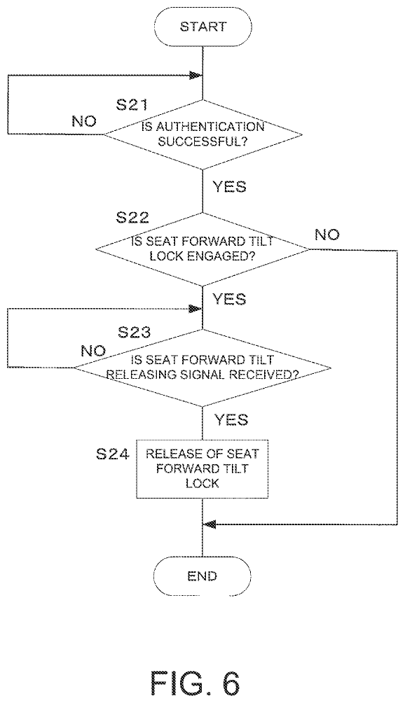

FIG. 6 shows a flowchart of a process to control a seat forward tilt lock releasing operation. The process may be also performed in the body ECU 24 and the seat ECU 30.

Firstly, communication with the smart key 10 is established to perform authentication of the smart key 10 (S21).

When the smart key 10 is authenticated (Yes is determined) in step S21, it is further determined whether or not the seat forward tilt lock is engaged in the driver's seat (S22). In a case where the seat forward tilt lock is not engaged, the lock releasing operation is not needed, and the process is terminated.

When Yes is determined in step S22, it is determined whether or not the seat forward tilt lock releasing signal is received (S23). When Yes is determined in step S23, the seat forward tilt lock is released (S24) and the seat is returned to a normal position. For example, the seat may be automatically returned to the specified position which is stored in the seat memory 36 as described above. It should be noted that releasing the lock of seat movement is an operation, while automatic returning to the specified position is optional and may not necessarily be performed. As a further optional operation, the seat may be moved to the specified position when an operation to shift the seat back rearward is performed after the lock is released.

Here, a vehicle stealing technique referred to as a relay attack has been known. According to the technique, in a case where a driver leaves a vehicle after locking the door of the vehicle and engaging the seat forward tilt lock, a person serving as a communication interceptor moves to a location close to the driver and attempts to establish communication with the smart key 10 carried by the driver. The communication can be established by transmitting radio waves similar to those emitted from the vehicle, for example. Then, the communication interceptor amplifies a signal from the smart key 10 and transmits the amplified signal to a person serving as a relay, and the relay transmits the signal to a person serving as a thief. After receiving the signal, the thief sends the received signal toward the vehicle, which allows the thief to unlock the door.

In this embodiment, because the seat forward tilt lock releasing signal is different from signals for controlling door locking and unlocking operations, the seat forward tilt lock is not released even though the door is unlocked, which can improve security. In particular, the seat forward tilt lock releasing signal is not transmitted unless the seat forward tilt locking switch 12c on the smart key 10 is explicitly operated, which can prevent accidental transmission of the seat forward tilt locking signal from occurring without the driver's intention. On the other hand, a convenient feature of the smart key 10 capable of unlocking the door can be maintained.

A door unlocking operation, which is not contained in the process shown in FIG. 6, may be performed after or before the seat forward tilt lock is released. In a case where the door lock is configured to be unlocked after the seat forward tilt lock is released, the seat forward tilt lock has been released at the time when the door is opened, which can eliminate a waiting period for the operation to release the seat forward tilt lock after the door is opened, and in turn improve convenience of the user.

### Timer Reservation

In the above-described example, the smart key 10 is used for engaging or releasing the seat forward tilt lock. When a mobile terminal 50, such as a smart phone, is used for performing control operation, a further advanced degree of control can be implemented.

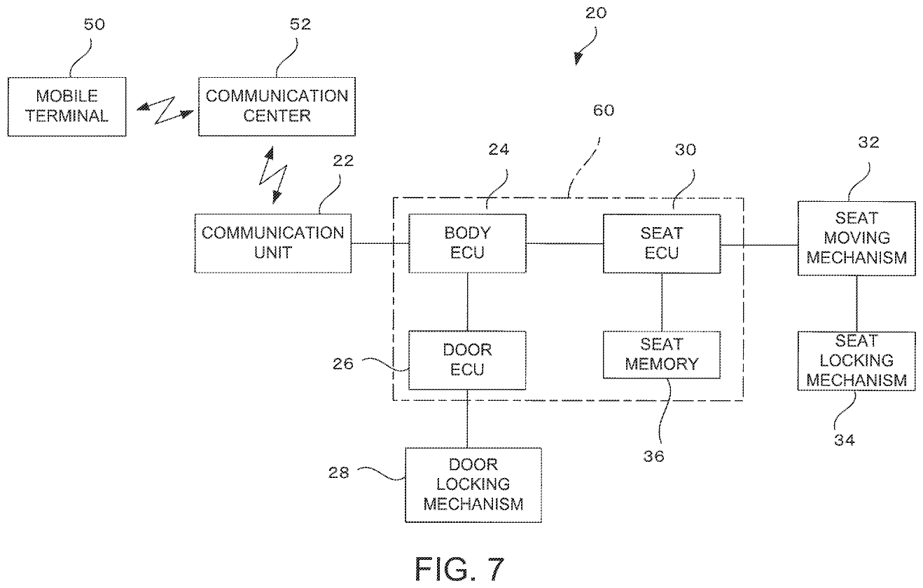

FIG. 7 is a diagram showing a system using the mobile terminal 50. As shown in FIG. 7, the mobile terminal 50 communicates with a communication center 52. The mobile terminal 50, such as a smart phone, is connected via a well-known communication circuit such as wireless communication, a telephone circuit, or the Internet, for example, to the communication center 52 which is also connected to the communication unit 22 in the vehicle via a communication circuit similar to that for the mobile terminal 50.

The mobile terminal 50 can set the operation to engage or release the seat forward tilt lock through a predetermined application which is installed in the mobile terminal 50.

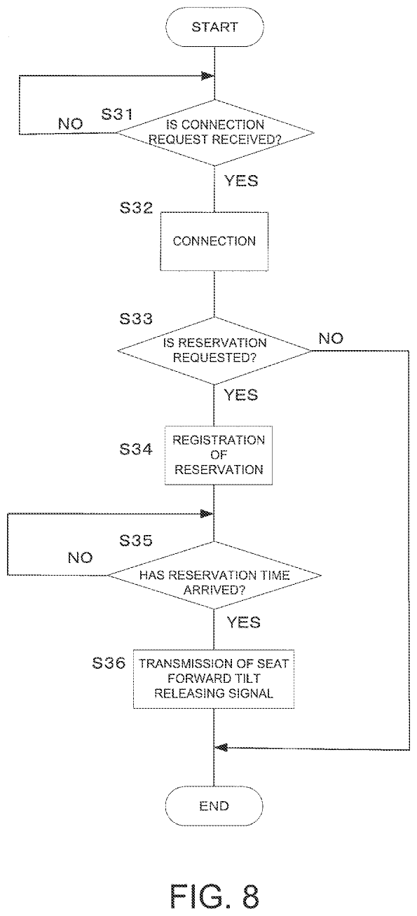

FIG. 8 shows a flowchart of a process to control a reservation for the seat forward tilt lock releasing operation using the mobile terminal 50. In this example, the communication center 52 performs the process and transmits the seat forward tilt lock releasing signal to the vehicle, and the seat forward tilt lock releasing operation is performed in the vehicle. Alternatively, the communication center 52 may be configured to supply the vehicle with information about the reservation for the seat forward tilt lock releasing operation, and the reservation may be registered and processed on the vehicle side. In this connection, the communication center 52 and the vehicle communicate with each other using well-known secure communication with which an appropriate level of security is retained.

When the user activates a predetermined application on the mobile terminal 50 and selects a reservation function, a connection request is transmitted from the mobile terminal 50 to the communication center (S31). When Yes is determined in step S31, the communication center 52 performs a predetermined authentication process to establish connection with the mobile terminal 50 (S32). Then, the communication center 52 determines whether or not a reservation for the seat forward tilt lock releasing operation is requested (S33). Specifically, the communication center 52 sends to the mobile terminal 50 an inquiry about whether a reservation is requested, and makes a determination about the reservation based on a response to the inquiry.

When Yes is determined in step S33, the reservation is registered based on data input from the mobile terminal 50 (S34). That is, a time at which the seat forward tilt lock is released is stored in a timer.

Here, the communication center 52 is able to send an inquiry about whether the seat forward tilt lock is engaged in the driver's seat. When the result of the inquiry shows that the seat forward tilt lock is not engaged, information about the result may be supplied to the mobile terminal 50, and information representing that the seat forward tilt lock is not engaged may be displayed on the mobile terminal 50. In this case, the process may further include inquiring of the user about whether to select activation of the seat forward tilt lock, transmitting, when the user selects the activation of the seat forward tilt lock, the seat forward tilt locking signal to the onboard device 20 for causing the onboard device 20 to perform the seat forward tilt locking operation, and then moving to the next step.

Referring back to the process illustrated in FIG. 8, whether or not the time reserved for the seat forward tilt lock releasing operation has arrived is determined in the timer (S35). When Yes is determined in step S35, the seat forward tilt lock releasing signal is transmitted (S36). The seat forward tilt lock releasing signal is supplied to the vehicle, and the seat forward tilt lock is released on the vehicle side.

It should be noted that in the above-described example, operation according to the above process is performed in the communication center 52, while the communication center 52 may simply function as a relay station, and the operation may be partially or entirely performed in the onboard device 20.

Similarly, the seat forward tilt locking operation may be performed in the mobile terminal 50, including the process of performing reservation operation.

1. A vehicle lock controlling system, comprising:
a door locking mechanism which locks or unlocks a door lock of a door in a vehicle;
a seat forward tilt locking mechanism which engages or releases a seat forward tilt lock in a driver's seat; and
a control unit which controls the door locking mechanism and the seat forward tilt locking mechanism;
wherein the control unit is configured to,
cause, when a door unlocking signal is received, the door locking mechanism to unlock the door lock, and
cause, when a seat forward tilt lock releasing signal is received, the seat forward tilt locking mechanism to release the seat forward tilt lock, the seat forward tilt lock releasing signal being different from the door unlocking signal.

2. The vehicle lock controlling system according to claim 1, wherein
the control unit is further configured to cause the seat forward tilt locking mechanism to engage the seat forward tilt lock when a seat forward tilt locking signal is received after the door is closed, and not to cause the seat forward tilt locking mechanism to engage the seat forward tilt lock when the seat forward tilt locking signal is received while the door is open.

3. The vehicle lock controlling system according to claim 1, wherein
the control unit is further configured to cause the door locking mechanism to unlock the door lock after the seat forward tilt lock is released, and not to cause the door locking mechanism to unlock the door lock while the seat forward tilt lock is engaged.

4. The vehicle lock controlling system according to claim 1, wherein:
operation to engage the seat forward tilt lock comprises tilting the driver's seat forward and lowering a sitting surface of the driver's seat, and
operation to release the seat forward tilt lock comprises recovering the driver's seat from a forward tilt position and recovering the sitting surface from a lowered position.

5. The vehicle lock controlling system according to claim 4, wherein:
the operation to engage the seat forward tilt lock further comprises moving the driver's seat to a forward position in a longitudinal direction, and
the operation to release the seat forward tilt lock further comprises recovering the driver's seat from the forward position.

6. The vehicle lock controlling system according to claim 1, wherein
the seat forward tilt lock releasing signal is wirelessly transmitted by pressing a seat forward tilt locking switch disposed on a smart key.

7. The vehicle lock controlling system according to claim 1, wherein
the seat forward tilt lock releasing signal is wirelessly transmitted by turning on a switch on an application installed in a mobile terminal.

8. The vehicle lock controlling system according to claim 1, wherein
the seat forward tilt lock releasing signal is wirelessly transmitted from a communication center.
